(19) United States
(12) Patent Application Publication
(10) Pub. No.: US 2024/0417292 A1
(43) Pub. Date: Dec. 19, 2024

(54) COMBINED PHOTOACTIVATED REDUCTION AND OXIDATION PROCESS AND SYSTEM FOR THE TREATMENT OF CONTAMINANTS IN WATER

(71) Applicant: ENSPIRED SOLUTIONS, Lansing, MI (US)

(72) Inventor: Suzanne Elizabeth Witt, Laingsburg, MI (US)

(73) Assignee: ENSPIRED SOLUTIONS, Lansing, MI (US)

(21) Appl. No.: 18/747,988

(22) Filed: Jun. 19, 2024

Related U.S. Application Data
(60) Provisional application No. 63/508,962, filed on Jun. 19, 2023.

(51) Int. Cl. C02F 1/70; C02F 1/72; C02F 101/30; C02F 101/36

(52) U.S. Cl. CPC C02F 1/70; C02F 1/722; C02F 2101/301; C02F 2101/36; C02F 2201/3223; C02F 2201/326

(57) ABSTRACT

A reactor system for treating and degrading a per- and polyfluorinated alkyl substances (PFAS) and organic material contaminated material includes a reaction vessel and an ultraviolet (UV) light source. An electron donor and surfactant solution is introduced into the reaction vessel configured to combine with UV light to degrade PFAS into fluoride ions and simple carbon compounds via a photoactivated advanced reduction processes (UV-ARP). An oxidant solution is added to the reaction vessel at a preset dosage and at a sufficient concentration to degrade the surfactant via an UV advanced oxidation process (UV-AOP). The UV light source can be activated and continuously emit UV light to degrade the surfactant and organic material until a desired reduction of surfactant concentration and reduction of PFAS concentration are achieved.

### CROSS-REFERENCE TO RELATED APPLICATIONS

This Application claims priority to and the benefit of U.S. Provisional Patent Application No. 63/508,962, titled “COMBINED PHOTOACTIVATED REDUCTION AND OXIDATION PROCESS FOR THE TREATMENT OF CONTAMINANTS IN WATER,” and filed on Jun. 19, 2023, the disclosure of which is incorporated herein by reference in its entirety for all purposes.

### FIELD

The present disclosure relates generally to the field of water treatment systems and processes for the removal of undesired contaminants.

### GOVERNMENT LICENSE RIGHTS

None

### BACKGROUND

Photoactivated advanced reduction processes (ARP) utilize an electron donor that generates a hydrated electron when exposed to ultraviolet (UV) light. The hydrated electrons are capable of reducing chemical bonds of highly recalcitrant compounds, such as per- and polyfluorinated alkyl substances (PFAS). Compounds such as PFAS are resistant to traditional UV water treatment methods, such as chlorine disinfection. Employing an ARP to selectively treat these compounds may provide a pathway to destroy some of the most recalcitrant contaminants in a sample.

In an example of photoactivated ARP, a surfactant is added to a solution to form a micelle that localizes PFAS and the electron donor in solution. This significantly enhances the reaction rate by bringing PFAS and the electron donor in close proximity and minimizing the effects of oxygen quenching of hydrated electrons. However, abundant surfactants are toxic to aquatic life and require additional remediation after ARP.

Typical methods to remove surfactants from water include adsorption, filtration and coagulation. Each of these methods results in secondary contamination in the form of a solid or sludge because the surfactant is only removed from water, not destroyed.

Additionally, photoactivated ARP processes may be inhibited by waters with low UV transmission (UVT), typically due to elevated levels of organic matter, and would benefit from pre-treatments that improve UVT in a sample.

U.S. Published Patent Application No. 2022/0401777 titled “NANO-REACTOR SYSTEM FOR DECOMPOSITION OF PER- AND POLYFLUOROALKYL SUBSTANCES,” is directed to a reactor system for decomposing at least one of a per- or polyfluoroalkyl substance (PFAS) and is incorporated by reference herein. The system and method includes a material having an interior surface that defines a compartment; a subaqueous liquid in the compartment; and an electron donor in the subaqueous liquid, the electron donor configured to release a hydrated electron upon ultraviolet (UV) irradiation.

U.S. Pat. No. 9,896,350 titled “METHOD OF DEGRADING PERFLUORINATED COMPOUND” is incorporated by reference herein. This patent is directed to a method for efficiently degrading a perfluorinated compound (PFC), through which the problems of harsh reaction conditions and less high defluorination rate existing in other methods for degrading PFCs are solved.

U.S. Pat. No. 11,072,574 titled “METHOD FOR DEGRADING PERFLUORINATED COMPOUNDS” is incorporated by reference herein. This patent is directed to a method for degrading perfluorinated compounds (PFCs).

Cetyltrimethylammonium bromide (CTAB), indoleacetic acid (IAA) and PFCs are mixed to form compact self-assembled micelles, and the self-assembled micelles are illuminated, so that PFCs are rapidly degraded and defluorinated in the micelles, thereby realizing the degradation of PFCs by using a self-assembled micelle system and improving the degradation efficiency of PFCs.

Accordingly, a need remains for improved systems and processes for treating contaminated material and waste streams and eliminating toxic surfactants from a discharge.

### SUMMARY

A reactor system for treating a contaminated material is provided. The reaction system of the present disclosure includes: (a) a reaction vessel configured for reacting a contaminated material, where the contaminated material includes per- and polyfluorinated alkyl substances (PFAS) and organic material; (b) an ultraviolet (UV) light source within the reaction vessel, configured to emit UV light at a controllable wavelength and strength; (c) an electron donor and surfactant solution configured to be added to the reaction vessel, where the electron and surfactant solution is configured to combine with UV light emitted from the UV light source to degrade PFAS into fluoride ions and simple carbon compounds via a photoactivated advanced reduction processes (UV-ARP); and (d) an oxidant solution configured to be added to the reaction vessel at a preset dosage and at a sufficient concentration to degrade additional contaminants via an UV advanced oxidation process (UV-AOP). The UV light source is configured to be activated and continuously emit UV light to degrade the surfactant and organic material until a desired reduction of surfactant concentration and reduction of PFAS concentration are achieved.

In an example, the reactor the reaction vessel is configured to initiate UV-AOP prior to UV-ARP and vice versa. UV-ARP and UV-AOP can be configured to occur within a single reaction vessel and are repeatable in a sequence for a preset number of times. In a further example, the oxidant solution includes an oxidant selected from the group consisting of hydrogen peroxide (H₂O₂), ozone, chlorine, persulfate, and combinations thereof. The oxidant solution can be configured to be provided at a weight to volume (w/v) concentration between 30-35%. In yet another example, the oxidant solution is configured to be dosed into the reaction vessel at increments of time between 10 and 15 minutes. In still a further example, the oxidant solution is configured to be dosed in aliquots of 0.3-3.3% volume to volume (v/v) of the contaminated material in the reaction vessel at least 3 doses every 10 to 15 minutes. The UV-ARP reaction can be configured to reduce PFAS is degraded by 90% or the original concentration prior to discharge. The UV-AOP reaction can be configured to degrade the surfactant into a head and tail portion sufficient for discharge. In yet an even further example, adding of the oxidant solution and the electron donor and surfactant solution are automated, preset, and/or programmable to achieve a desired discharge concentration of 90% PFAS degradation.

The present disclosure further provides for a process for treating a contaminated material. The process includes the steps of: (a) adding an electron donor and surfactant solution to a reaction vessel for reacting a contaminated material within the reaction vessel, wherein the contaminated material includes per- and polyfluorinated alkyl substances (PFAS) and organic material; (b) activating an ultraviolet (UV) light source within the reaction vessel, configured to emit UV light at a controllable wavelength and strength; (c) degrading the PFAS and organic material into fluoride ions and carbon compounds by reacting with the electron and surfactant solution and combined with the UV light emitted from the UV light source via a photoactivated advanced reduction processes (UV-ARP); (d) adding an oxidant solution to the reaction vessel at a preset dosage and at a sufficient concentration to degrade additional contaminants and surfactant via an UV advanced oxidation process (UV-AOP); and (e) degrading the surfactant and organic material until a desired reduction of surfactant concentration and reduction of PFAS concentration are achieved.

In an example, the UV-AOP is implemented prior to UV-ARP. In another example, the UV-ARP and UV-AOP are implemented repeatedly in a preset sequence and for a preset number of dosing events. The oxidant solution can be dosed into the reaction vessel at increments of time between 10 and 15 minutes. In a further example, the oxidant solution is dosed in aliquots of 0.3-3.3% volume to volume (v/v) of the contaminated material in the reaction vessel at least 3 doses every 10 to 15 minutes. The process can further include a discharge step where the PFAS is degraded by 90% of the original concentration prior to discharge. The surfactant can be degraded into a head and tail portion sufficient for discharge.

The present disclosure still further provides for a process where the oxidant solution includes a hydrogen peroxide (H₂O₂) solution at a weight to volume (w/v) concentration between 30-35% and is dosed into the reaction vessel at increments of time between 10 and 15 minutes in aliquots of 0.3-3.3% volume to volume (v/v) of the contaminant in the reaction vessel for least 3 doses and the PFAS is degraded by 90% of the original concentration prior to discharge and the surfactant is degraded into a head and tail portion sufficient for discharge.

For purposes of summarizing the disclosure, certain aspects, advantages, and novel features of the disclosure have been described herein. It is to be understood that not necessarily all such advantages may be achieved in accordance with any one particular embodiment of the disclosure. Thus, the disclosure may be embodied or conducted in a manner that achieves or optimizes one advantage or group of advantages as taught herein without necessarily achieving other advantages as may be taught or suggested herein. The features of the disclosure which are believed to be novel are particularly pointed out and distinctly claimed in the concluding portion of the specification. These and other features, aspects, and advantages of the present disclosure will become better understood with reference to the following drawings and detailed description.

### DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A is a schematic of an example reactor system for conducting sequential advanced reduction processes (ARP) and AOP to treat PFAS, surfactants, and other organic matter in water according to the present disclosure.

FIG. 1B is a schematic of another example reactor system for conducting sequential advanced reduction processes (ARP) and advanced oxidation processes (AOP) to treat per- and polyfluorinated alkyl substances (PFAS and PFOA), surfactants, and other organic matter in water according to the present disclosure.

FIG. 2A is a graph illustrating an example percent degradation of 1 mg/L PFOA as a function of UV dose during ARP treatment (step 1 of FIG. 1A).

FIG. 2B, is a graph illustrating an example percent degradation of the cationic surfactant cetyltrimethylammonium bromide (CTAB, •) and percent UV transmittance at 254 nm (×) over time during UV-AOP of solution after UV-ARP of PFAS (step 2 in FIG. 1A).

### DETAILED DESCRIPTION

The present disclosure provides for a process and system that employs sequential photoactivated advanced reduction and oxidation processes to treat a broad range of contaminants in water. This process utilizes an ultraviolet (UV) reactor and timed chemical dosing to perform stepwise photochemical reactions to mineralize contaminants that range in concentration, stability and toxicity. In an example, the system uses a single UV reactor. UV light generally refers to light emitted within a range of wavelengths. Typically, UV light is electromagnetic radiation of wavelengths of 100-400 nanometers, shorter than that of visible light, but longer than X-rays.

Degrading a surfactant in-situ is a desirable approach to avoid the generation of secondary waste. Surfactants can be rapidly degraded in water using UV-based advanced oxidation processes (AOPs). During a UV-based AOP, highly reactive radical species, such as hydroxyl, chlorine, or sulfate radicals for example, are generated in solution when a UV light-activated oxidant, such as H₂O₂, ozone, chlorine, persulfate, or combinations thereof, is exposed to UV light. The reactive radical species generated upon UV exposure oxidize the chemical bonds of contaminants. The dose of oxidant is provided in sufficient excess of the surfactant concentration so that the surfactant concentration is reduced. In an example, the surfactant concentration can be reduced by greater than or equal to about 90%. Moreover, residual PFAS leftover from an advanced reduction process (ARP) step has potential to be degraded during the AOP step. UV-based AOPs have an added benefit of degrading dissolved or suspended organic matter in the solution, which improves the clarity of the solution and reduces chemical and biological oxygen demands. Improved sample clarity, or UV transmission (UVT), has the potential to improve the efficiency of UV-ARP treatment when UV-AOP is implemented as an additional step.

UV-ARP and UV-AOP systems have been previously used in isolation and to target specific contaminants. However, the combination of UV-ARP and UV-AOP in a system and process to comprehensively treat water for PFAS, surfactants and organic matter is achievable by way of the present disclosure.

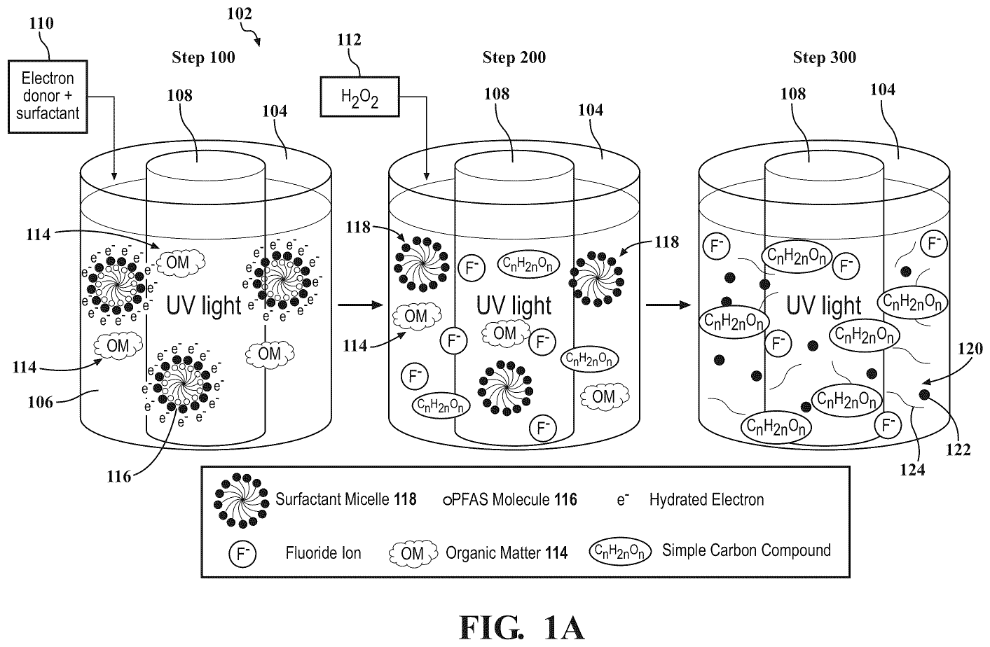

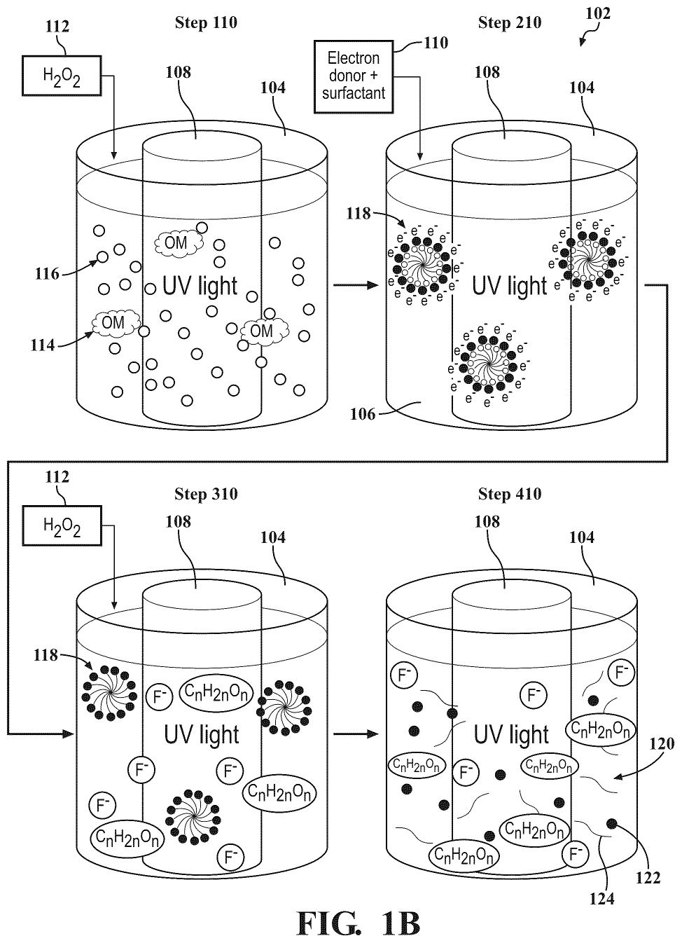

Both UV-ARP and UV-AOP are UV activated. Accordingly, the present disclosure provides for a system and process of switching from one to the other in a single reactor system by timed reagent dosing (FIG. 1A or 1B). In an example process, electron donor and surfactant are added to PFAS-contaminated water in a reaction vessel. UV light is activated on to initiate ARP degradation of PFAS. The PFAS molecules are degraded to form free fluoride ions and simple carbon compounds.

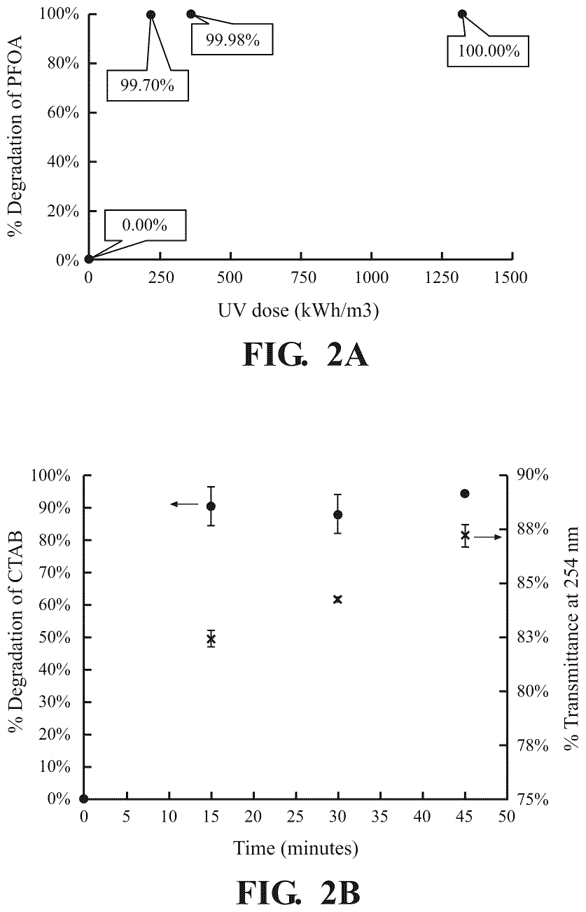

AOP is initiated by dosing the reaction vessel with a UV light-activated oxidant solution while maintaining and/or adding UV light. In an example, the dosing solution is about 30-35% weight to volume (w/v) of an oxidant solution, like a hydrogen peroxide (H₂O₂) solution. In an example, oxidant solution may include H₂O₂, ozone, chlorine, persulfate, or combinations thereof. The reaction can be dosed over a predetermined time corresponding to a predetermined dosage quantity. In an example, the reaction vessel is dosed every 10-15 minutes with 0.3-3.3% volume/volume (v/v) aliquots of the H₂O₂ solution for a total of three doses. The UV/H₂O₂-AOP degrades the surfactant molecules and organic matter, resulting in a lower biological and chemical oxygen demand. In this example, after a full treatment cycle, PFAS concentrations are reduced by at least two orders of magnitude, and the solution is transparent in color with degradation of surfactants (See FIG. 2B). The degradation of surfactants can be greater than or equal to about 90%. The order of operation of whether an AOP or ARP process within a reaction vessel or reaction system can be interchangeable.

Referring to FIG. 1A, an example reactor system 102 is shown schematically. In this example, a reactor system 102 for sequential PFAS and surfactant degradation according to the present disclosure is provided. Reaction system 102 includes a reaction vessel 104 configured for receiving and holding contaminated material 106 (interchangeably referred to as contaminated water). A UV light source 108 is provided within reaction vessel 104 and configured to expose any contaminated material 106 to UV light within the reaction vessel 104. The UV light source 108 can be configured to expose most of the contaminated material 106 throughout the reaction vessel 104. In another example, a stirring or mixing mechanism (not shown) can optionally be included for better or well mixed dispersion.

FIG. 1A shows an example process of treating contaminated material 106. The process includes, but is not limited to, the following steps:

In step 100, an electron donor and surfactant solution 110 is added to reaction vessel 104. Contaminated material 106, in this example, can include, but is not limited to, organic matter (OM) 114 and PFAS 116. When the UV light source 108 is activated (i.e., turned on), a photoactivated reductive defluorination (PRD) ARP reaction is initiated to degrade PFAS 116 into fluoride ions (F—) and simple carbon compounds (CₙH₂ₙOₙ) as shown in step 200 and step 300. In this example, the surfactant and electron donor (e-) molecules form micelle structures 118 with the PFAS 116 in solution 106.

In step 200, the UV light source 108 is kept activated (i.e., on) while an oxidant (i.e., H₂O₂) solution 112 is added. The adding of solution 112 is dosed in time increments. In this example, the solution is an H₂O₂ 30-35% weight to volume (w/v) solution dosed into the reaction at 0.3 to 3.3% volume to volume (v/v) per dose every 10 to 15 minutes for a total of 3 doses. The UV/H₂O₂ AOP degrades the surfactant molecules 118 and organic matter 114. The surfactant 118 includes a head portion 122 and a tail portion 124. In an example, the head portion 122 is hydrophilic and the tail portion is hydrophobic. Separating the head portion 122 from the tail portion 122 degrades the surfactant molecule 118.

In step 300, the resulting solution 120 of degraded surfactant 118 into head portion 122 and tail portion 124, simplified carbon compounds (CₙH₂ₙOₙ), and fluoride ions (F—) may be discharged.

Referring to FIG. 11B, an example reactor system 202 is shown schematically. In this example, a reactor system 202 for sequential PFAS and surfactant degradation according to the present disclosure is provided. Reaction system 202 includes a reaction vessel 104 configured for receiving and holding contaminated material 106 (interchangeably referred to as contaminated water). A UV light source 108 is provided within reaction vessel 104 and configured to expose any contaminated material 106 to UV light within the reaction vessel 104. The UV light source 108 can be configured to expose most of the contaminated material 106 throughout the reaction vessel 104. In another example, a stirring or mixing mechanism (not shown) can optionally be included for better or well mixed dispersion.

The process of the present disclosure provides for treating contaminated material 106 within reaction system 202 with a first oxidant step 110 followed by an electron donor and surfactant step 210. Contaminated material 106, in this example, can include, but is not limited to, organic matter (OM) 114 and PFAS 116. The process includes, but is not limited to, the following steps:

In step 110, an oxidant (i.e., H₂O₂) solution 112 is added into reaction vessel 104 to treat contaminated material 106. The UV light 108 is activated. The adding of solution 112 can be dosed in time increments. In this example, the solution is an H₂O₂ 30-35% weight to volume (w/v) solution dosed into the reaction at 0.3 to 3.3% volume to volume (v/v) per dose every 10 to 15 minutes for a total of 3 doses. The UV/H₂O₂ AOP degrades the organic matter 114 to improve sample clarity.

In step 210, the UV light source 108 is kept activated (i.e., on) while an electron donor and surfactant solution 110 is added to reaction vessel 104 to initiate the PRD reaction and degrade the PFAS 116. The surfactant and electron donor (e-) molecules form micelle structures 118 with the PFAS 116 in solution 106. The UV light source 108 initiates a photoactivated reductive defluorination (PRD) ARP reaction to degrade PFAS 116 into fluoride ions (F—) and simple carbon compounds (CₙH₂ₙOₙ) as shown in step 310 and step 410.

In step 310, the UV light 108 is kept on and solution 112 is again dosed into the reaction vessel 104 to degrade the surfactant 118 via UV/H₂O₂ AOP. The surfactant 118 includes a head portion 122 and a tail portion 124. In an example, the head portion 122 is hydrophilic and the tail portion is hydrophobic. Separating the head portion 122 from the tail portion 122 degrades the surfactant molecule 118.

In step 410, the resulting solution 120 of degraded surfactant 118 into head portion 122 and tail portion 124, simplified carbon compounds (CₙH₂ₙOₙ), and fluoride ions (F—) may be discharged.

FIGS. 2A and 2B illustrate two charts with degradation results. FIG. 2A shows percent degradation of 1 mg/L perfluorooctanoic acid (PFOA) as a function of UV dose during ARP treatment (step 100 in FIG. 1A). FIG. 2B shows percent degradation of the cationic surfactant cetyltrimethylammonium bromide (CTAB, •) and percent UV transmittance at 254 nm (×) over time during UV-AOP of solution after UV-ARP of PFAS (step 200 in FIG. 1A). In this example, the solution was spiked with one aliquot of 0.3% (v/v) of 30% (w/v) H₂O₂ at t=0-, 15-, and 30-minutes while being irradiated with a low-pressure UV lamp. Error bars represent standard deviation of replicate experiments.

The system and process shown in FIGS. 1A and 1B can further be repeated to achieve a desired outcome. In some embodiments, the UV-AOP reaction is initiated first followed by the UV-ARP reaction and vice versa. In another example, the system and process includes alternating dosages to initiate the UV-AOP and UV-ARP reactions for preset periods of time configured to achieve a desired contamination degradation. During this time, the UV light source can be configured to emit UV light continuously or at preset intervals with varying intensities and wavelengths. The system and process can occur in a single reaction vessel. In another example, the system can be automated through a programmable computer medium coupled to a release and dosage schedule configured with a UV emission dosage schedule to achieve a desirable outcome and sufficiently degraded discharge. In an example, the reaction vessel is coupled to an oxidant reservoir and a surfactant and electron donor reservoir and the system/process can be initiated through a programmable and automated system.

It should be noted that the steps described in the method of use can be conducted in many different orders and any number of times according to user preference. The use of “step of” should not be interpreted as “step for”, in the claims herein and is not intended to invoke the provisions of 35 U.S.C. § 314 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the disclosure described herein are exemplary and numerous modifications, variations and rearrangements can be readily envisioned to achieve substantially equivalent results, all of which are intended to be embraced within the spirit and scope of the disclosure. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A reactor system for treating a contaminated material comprising:
(a) a reaction vessel configured for reacting a contaminated material, wherein the contaminated material includes per- and polyfluorinated alkyl substances (PFAS) and organic material;
(b) an ultraviolet (UV) light source within the reaction vessel, configured to emit UV light at a controllable wavelength and strength;
(c) an electron donor and surfactant solution configured to be added to the reaction vessel, wherein the electron and surfactant solution is configured to combine with UV light emitted from the UV light source to degrade PFAS into fluoride ions and simple carbon compounds via a photoactivated advanced reduction processes (UV-ARP); and
(d) an oxidant solution configured to be added to the reaction vessel at a preset dosage and at a sufficient concentration to degrade additional contaminants via an UV advanced oxidation process (UV-AOP);
wherein the UV light source is configured to be activated and continuously emitting UV light transmission to degrade the surfactant and organic material until a desired reduction of surfactant concentration and reduction of PFAS concentration are achieved.

2. The reactor system of claim 1, wherein the reaction vessel is configured to initiate UV-AOP prior to UV-ARP and vice versa.

3. The reactor system of claim 1, wherein UV-ARP and UV-AOP are configured to occur within a single reaction vessel and are repeatable in a sequence for a preset number of times.

4. The reactor system of claim 1, wherein the oxidant solution includes an oxidant selected from the group consisting of hydrogen peroxide (H₂O₂), ozone, chlorine, persulfate, and combinations thereof.

5. The reactor system of claim 1, wherein the oxidant solution is configured to be provided at a weight to volume (w/v) concentration between 30-35%.

6. The reactor system of claim 1, wherein the oxidant solution is configured to be dosed into the reaction vessel at increments of time between 10 and 15 minutes.

7. The reactor system of claim 1, wherein the oxidant solution is configured to be dosed in aliquots of 0.3-3.3% volume to volume (v/v) of the contaminated material in the reaction vessel at least 3 doses every 10 to 15 minutes.

8. The reactor system of claim 1, wherein the UV-ARP reaction is configured to reduce PFAS is degraded by 90% of the original concentration prior to discharge.

9. The reactor system of claim 1, wherein the UV-AOP reaction is configured to degrade the surfactant into a head and tail portion sufficient for discharge.

10. The reactor system of claim 1, wherein the adding of the oxidant solution and the electron donor and surfactant solution are automated, preset, and/or programmable to achieve a desired discharge concentration of 90% PFAS degradation.

11. A process for treating a contaminated material comprising:
(a) adding an electron donor and surfactant solution to a reaction vessel for reacting a contaminated material within the reaction vessel, wherein the contaminated material includes per- and polyfluorinated alkyl substances (PFAS) and organic material;
(b) activating an ultraviolet (UV) light source within the reaction vessel, configured to emit UV light at a controllable wavelength and strength;
(c) degrading the PFAS and organic material into fluoride ions and carbon compounds by reacting with the electron and surfactant solution and combined with the UV light emitted from the UV light source via a photoactivated advanced reduction processes (UV-ARP);
(d) adding an oxidant solution to the reaction vessel at a preset dosage and at a sufficient concentration to degrade additional contaminants and surfactant via an UV advanced oxidation process (UV-AOP); and
(e) degrading the surfactant and organic material until a desired reduction of surfactant concentration and reduction of PFAS concentration are achieved.

12. The process of claim 11, wherein UV-AOP is implemented prior to UV-ARP or vice versa.

13. The process of claim 11, wherein UV-ARP and UV-AOP are implemented repeatedly in a preset sequence and for a preset number of dosing events.

14. The process of claim 11, wherein the oxidant solution includes an oxidant selected from the group consisting of hydrogen peroxide (H₂O₂), ozone, chlorine, persulfate, and combinations thereof.

15. The process of claim 11, wherein the oxidant solution is provided at a weight to volume (w/v) concentration between 30-35%.

16. The process of claim 11, wherein the oxidant solution is dosed into the reaction vessel at increments of time between 10 and 15 minutes.

17. The process of claim 11, wherein the oxidant solution is dosed in aliquots of 0.3-3.3% volume to volume (v/v) of the contaminated material in the reaction vessel at least 3 doses every 10 to 15 minutes.

18. The process of claim 11, wherein the PFAS is degraded by 90% of the original concentration prior to discharge.

19. The process of claim 11, wherein the surfactant is degraded into a head and tail portion sufficient for discharge.

20. The process of claim 11, wherein the oxidant solution is provided at a weight to volume (w/v) concentration between 30-35% and is dosed into the reaction vessel at increments of time between 10 and 15 minutes in aliquots of 0.3-3.3% volume to volume (v/v) of the contaminant in the reaction vessel for least 3 doses and the PFAS is degraded by 90% of the original concentration prior to discharge and the surfactant is degraded into a head and tail portion sufficient for discharge.
